(19) United States
(12) Patent Application Publication
(10) Pub. No.: US 2013/0315114 A1
(43) Pub. Date: Nov. 28, 2013

(54) METHOD AND DEVICE FOR SCHEDULING IN CARRIER AGGREGATE SYSTEM

(71) Applicants: Dong Youn Seo, Anyang-si (KR); Joon Kui Ahn, Anyang-si (KR); Suck Chel Yang, Anyang-si (KR); Min Gyu Kim, Anyang-si (KR); Bong Hoe Kim, Anyang-si (KR)

(72) Inventors: Dong Youn Seo, Anyang-si (KR); Joon Kui Ahn, Anyang-si (KR); Suck Chel Yang, Anyang-si (KR); Min Gyu Kim, Anyang-si (KR); Bong Hoe Kim, Anyang-si (KR)

(73) Assignee: LG ELECTRONICS INC., Seoul (KR)

(21) Appl. No.: 13/984,139

(22) PCT Filed: Feb. 10, 2012
(86) PCT No.: PCT/KR12/01003

§ 371 Date: Aug. 7, 2013

Related U.S. Application Data
(60) Provisional application No. 61/441,646, filed on Feb. 10, 2011.
(60) Provisional application No. 61/453,103, filed on Mar. 15, 2011.
(60) Provisional application No. 61/555,491, filed on Nov. 4, 2011.
(60) Provisional application No. 61/560,286, filed on Nov. 15, 2011.

(51) Int. Cl. H04J 3/16

(52) U.S. Cl. CPC H04J 3/1694
USPC 370/280

(57) ABSTRACT

According to one embodiment, a scheduling method of a base station (BS) in a carrier aggregation system includes: transmitting uplink-downlink (UL-DL) configuration information on a time division duplex (TDD) frame used in a second serving cell through a first serving cell; and communicating with a user equipment (UE) through a subframe of the second serving cell configured by the UL-DL configuration information, wherein the first serving cell and the second serving cell are serving cells allocated to the UE.

### TECHNICAL FIELD

The present invention relates to wireless communications, and more particularly, to a method and apparatus for scheduling in a wireless communication system supporting carrier aggregation.

### BACKGROUND ART

One of the most important requirements of a next generation wireless communication system is to support a high data rate. For this, various techniques such as multiple input multiple output (MIMO), cooperative multiple point transmission (CoMP), relay, etc., have been under research, but the most fundamental and reliable solution is to increase a bandwidth.

However, a frequency resource is in a saturation state at present, and various schemes are partially used in a wide frequency band. For this reason, in order to ensure a broadband bandwidth to satisfy a required higher data rate, a system is designed such that a basic requirement which allows separate bands to operate respective independent systems is satisfied, and a carrier aggregation (CA) is introduced. In concept, the CA aggregates a plurality of bands into one system. In this case, a band that can be independently managed is defined as a component carrier (CC).

To support growing transmission capacity, it is considered in the latest communication standard (e.g., 3GPP LTE-A or 802.16m) to expand its bandwidth to 20 MHz or higher. In this case, a wideband is supported by aggregating one or more CCs. For example, if one CC corresponds to a bandwidth of 5 MHz, four carriers are aggregated to support a bandwidth of up to 20 MHz. A system supporting carrier aggregation in this manner is called a carrier aggregation system.

In the conventional carrier aggregation system, all carriers allocated to one user equipment use the same type of frame structures. That is, all carriers use a frequency division duplex (FDD) frame or a time division duplex (TDD) frame. However, it is considered that each carrier uses different types of frames in a future carrier aggregation system.

Accordingly, there is a need to consider a method of performing scheduling in a carrier aggregation system in which carriers using different types of frame structures are allocated to one user equipment.

### SUMMARY OF INVENTION

### Technical Problem

The present invention provides a method and apparatus for scheduling in a carrier aggregation system.

### Technical Solution

According to an aspect of the present invention, there is provided a scheduling method of a base station (BS) in a carrier aggregation system. The method includes: transmitting uplink-downlink (UL-DL) configuration information on a time division duplex (TDD) frame used in a second serving cell through a first serving cell; and communicating with a user equipment (UE) through a subframe of the second serving cell configured by the UL-DL configuration information, wherein the first serving cell and the second serving cell are serving cells allocated to the UE.

In the aforementioned aspect of the present invention, the first serving cell may be a primary cell in which the UE performs an initial connection establishment procedure or a connection re-establishment procedure with respect to the BS.

In addition, the second serving cell may be a secondary cell additionally allocated to the UE in addition to the primary cell.

In addition, the first serving cell may be a serving cell in which the UE establishes a radio resource control (RRC) connection with the BS, and the second serving cell may be a serving cell additionally allocated to the UE.

In addition, the first serving cell may use a frequency division duplex (FDD) frame in which downlink transmission and uplink transmission are performed in different frequency bands.

In addition, the second serving cell may use a TDD frame in which downlink transmission and uplink transmission are performed in the same frequency band at different times.

In addition, all of the first serving cell and the second serving cell may use a TDD frame, while using different UL-DL configurations.

In addition, the UL-DL configuration information may indicate each of subframes existing in each TDD frame used in the second serving cell as a UL subframe, a DL subframe, or a special subframe.

In addition, the UL-DL configuration information may indicate each TDD frame used in the second serving cell as a UL frame or a DL frame in a unit of frame.

In addition, if two consecutive frames of the second serving cell are allocated to different transmission links by the UL-DL configuration information, at least one of subframes adjacent to a boundary of the two consecutive frames may be configured to a special subframe.

In addition, the method may further include transmitting UE-specific UL-DL configuration information applied to the UE through the first serving cell.

In addition, if a subframe configured by the UE-specific UL-DL configuration information is allocated to a transmission link different from that of a subframe configured by the UL-DL configuration information, the subframe may not be used by the UE.

In addition, the UL-DL configuration information may be transmitted through an RRC message.

In addition, the UL-DL configuration information may be the same information as UL-DL configuration information to be broadcast as system information in the second serving cell.

According to another aspect of the present invention, there is provided a method of operating a UE in a carrier aggregation system. The method includes: receiving UL-DL configuration information on a TDD frame used in a second serving cell through a first serving cell; and communicating with a BS through a subframe of the second serving cell configured by the UL-DL configuration information, wherein the first serving cell and the second serving cell are serving cells allocated to the UE.

In the aforementioned aspect of the present invention, the UL-DL configuration information may be the same information as UL-DL configuration information to be broadcast as system information in the second serving cell.

According to another aspect of the present invention, a method of operating a UE in a carrier aggregation system is provided. The method includes: receiving scheduling information on a second subframe of a second serving cell through a first subframe of a first serving cell; determining a UL-DL configuration of the second subframe on the basis of the scheduling information; and communicating with a BS in the second subframe, wherein the UL-DL configuration indicates a specific subframe type to which the second subframe belongs between a UL subframe and a DL subframe.

In the aforementioned aspect of the present invention, the scheduling information may be a DL grant or a UL grant.

In addition, if the DL grant schedules the second subframe, the second subframe may be configured to a DL subframe.

In addition, if the UL grant schedules the second subframe, the second subframe may be configured to a UL subframe.

According to another aspect of the present invention, there is provided an apparatus including: a radio frequency (RF) unit transmitting and receiving a radio signal; and a processor coupled to the RF unit, wherein the processor transmits UL-DL configuration information on a TDD frame used in a second serving cell through a first serving cell, and transmits and receives a signal through a subframe of the second serving cell configured by the UL-DL configuration information, and wherein the first serving cell uses an FDD frame as a primary cell, and the second serving cell uses a TDD frame as a secondary cell.

### Advantageous Effects

According to the present invention, an uplink (UL)-downlink (DL) configuration of secondary cells is transmitted through a primary cell of which a communication channel is connected to a user equipment in a carrier aggregation system, thereby being able to decrease a necessity of performing persistent monitoring on the secondary cells of the user equipment. In addition, a UL-DL configuration of secondary cells which use a time division duplex (TDD) frame can be configured in a variable manner, thereby being able to flexibly cope with a change in UL/DL data traffic.

### DESCRIPTION OF DRAWINGS

FIG. 1 shows a wireless communication system.

FIG. 2 shows a radio frame structure used in frequency division duplex (FDD).

FIG. 3 shows a radio frame structure used in time division duplex (TDD).

FIG. 4 shows an example of a resource grid for one downlink (DL) slot.

FIG. 5 shows a structure of a DL subframe.

FIG. 6 shows a structure of an uplink (UL) subframe.

FIG. 7 shows an example of comparing a carrier aggregation system with the conventional single-carrier system.

FIG. 8 shows a subframe structure for cross-carrier scheduling in a carrier aggregation system.

FIG. 9 shows a method for scheduling between a base station (BS) and a user equipment (UE) according to an embodiment of the present invention.

FIG. 10 shows an example of an unused subframe.

FIG. 11 shows an example of performing a UL-DL configuration of a secondary cell in a unit of subframe.

FIG. 12 shows a method of scheduling a secondary cell according to another embodiment of the present invention.

FIG. 13 shows a structure of a BS and a UE according to an embodiment of the present invention.

### MODE FOR INVENTION

Long term evolution (LTE) of the 3^{rd} generation partnership project (3GPP) standard organization is a part of an evolved-universal mobile telecommunications system (E-UMTS) using an evolved-universal terrestrial radio access network (E-UTRAN). The LTE employs an orthogonal frequency division multiple access (OFDMA) in a downlink and employs single carrier-frequency division multiple access (SC-FDMA) in an uplink. LTE-advance (LTE-A) is an evolution of the LTE. For clarity, the following description will focus on the 3GPP LTE/LTE-A. However, technical features of the present invention are not limited thereto.

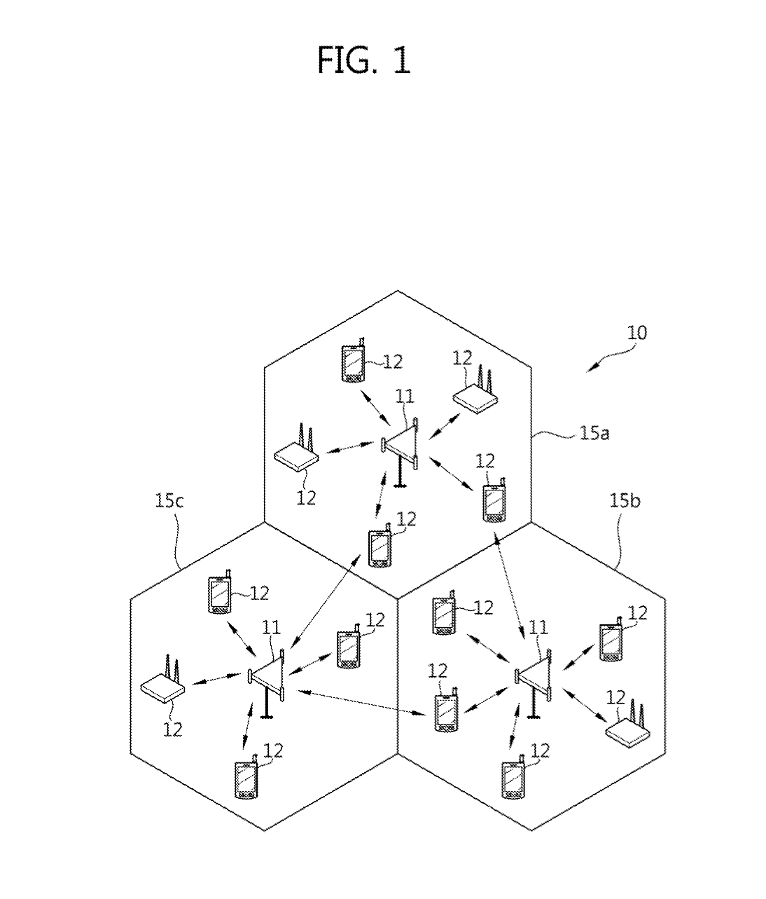

FIG. 1 shows a wireless communication system.

Referring to FIG. 1, a wireless communication system 10 includes at least one base station (BS) 11. Each BS 11 provides a communication service to a specific geographical region. The geographical region can be divided into a plurality of sub-regions 15a, 15b, and 15c, each of which is called a sector. The BS 11 is generally a fixed station that communicates with a user equipment (UE) 12 and may be referred to as another terminology, such as an evolved node-B (eNB), a base transceiver system (BTS), an access point, an access network (AN), etc.

The UE 12 may be fixed or mobile, and may be referred to as another terminology, such as a mobile station (MS), a user terminal (UT), a subscriber station (SS), a wireless device, a personal digital assistant (PDA), a wireless modem, a handheld device, an access terminal (AT), etc.

Hereinafter, a downlink (DL) implies communication from the BS 11 to the UE 12, and an uplink (UL) implies communication from the UE 12 to the BS 11.

The wireless communication system 10 may be a system supporting bidirectional communication. The bidirectional communication may be performed by using a time division duplex (TDD) mode, a frequency division duplex (FDD) mode, etc. When in the TDD mode, UL transmission and DL transmission use different time resources. When in the FDD mode, UL transmission and DL transmission use different frequency resources. The BS 11 and the UE 12 can communicate with each other by using a radio resource called a radio frame.

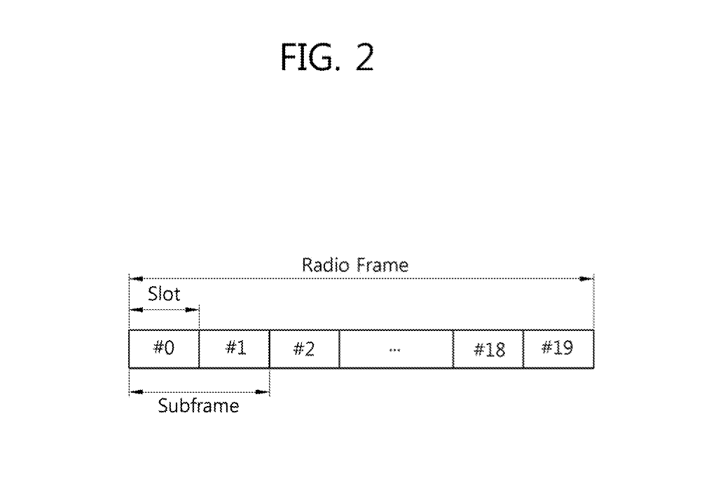

FIG. 2 shows a radio frame structure used in FDD.

Referring to FIG. 2, a radio frame used in FDD (hereinafter, an FDD frame) consists of 10 subframes in a time domain. One subframe consists of 2 slots in the time domain. One subframe may have a length of 1 millisecond (ms), and one slot may have a length of 0.5 ms. A time for transmitting one subframe is defined as a transmission time interval (TTI). The TTI may be a minimum unit of scheduling.

One slot may include a plurality of orthogonal frequency division multiplexing (OFDM) symbols in the time domain. Since the 3GPP LTE uses OFDMA in a downlink, one symbol period is represented with the OFDM symbol. The OFDM symbol can be referred to as other terms according to a multiple access scheme. For example, the OFDM symbol can also be referred to as an SC-FDMA symbol when SC-FDMA is used as an uplink multiple-access scheme. Although it is described herein that one slot includes 7 OFDM symbols, the number of OFDM symbols included in one slot may change depending on a cyclic prefix (CP) length. According to 3GPP TS 36.211 V8.5.0(2008-12), in case of a normal CP, one subframe includes 7 OFDM symbols, and in case of an extended CP, one subframe includes 6 OFDM symbols. The radio frame structure is for exemplary purposes only, and thus the number of subframes included in the radio frame and the number of slots included in the subframe may change variously.

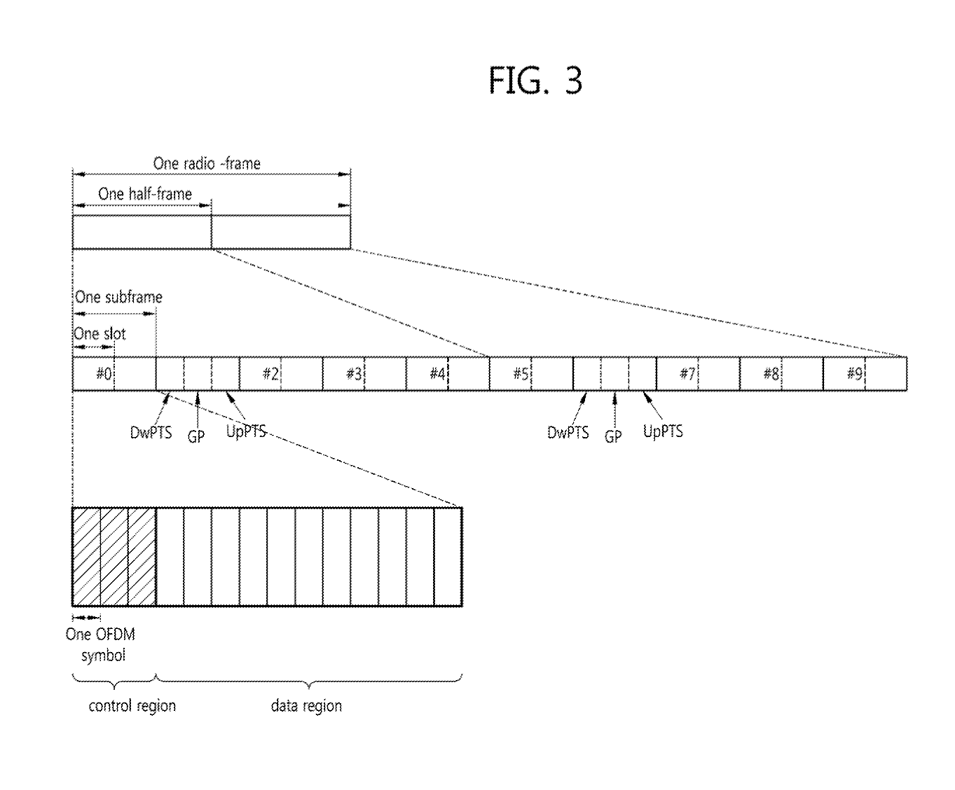

FIG. 3 shows a radio frame structure used in TDD.

Referring to FIG. 3, a radio frame used in TDD (hereinafter, a TDD frame) consists of 10 subframes indexed from 0 to 9. One subframe consists of 2 consecutive slots. For example, one subframe may have a length of 1 millisecond (ms), and one slot may have a length of 0.5 ms.

One slot may include a plurality of orthogonal frequency division multiplexing (OFDM) symbols in a time domain. Although it is described herein that one slot includes 7 OFDM symbols, the number of OFDM symbols included in one slot may change depending on a cyclic prefix (CP) length. According to 3GPP TS 36.211 V8.7.0, in case of a normal CP, one slot includes 7 OFDM symbols, and in case of an extended CP, one slot includes 6 OFDM symbols.

A subframe having an index #1 and an index #6 is called a special subframe, and includes a downlink pilot time slot (DwPTS), a guard period (GP), and an uplink pilot time slot (UpPTS). The DwPTS is used in a UE for initial cell search, synchronization, or channel estimation. The UpPTS is used in a BS for channel estimation and uplink transmission synchronization of the UE. The GP is a period for removing interference which occurs in an uplink due to a multi-path delay of a downlink signal between the uplink and a downlink. Table 1 below shows an example of a configuration of a special subframe.

TABLE 1

| | Normal cyclic prefix in | | | Extended cyclic prefix in | | |
|---|---|---|---|---|---|---|
| | downlink | | | downlink | | |
| | | UpPTS | | | UpPTS | |
| | | Normal | | | Normal | |
| | | cyclic | Extended | | cyclic | Extended |
| Special | | prefix | cyclic | | prefix | cyclic |
| subframe | | in | prefix | | in | prefix in |
| configuration | DwPTS | uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

In Table 1 above, Tₛ=1/(30720) ms.

In TDD, a downlink (DL) subframe and an uplink (UL) subframe coexist in one radio frame. Table 2 below shows an example of a UL-DL configuration (also referred to as a DL-UL configuration) of a radio frame.

TABLE 2

| | Switch- | | | | | | | | | | |
|---|---|---|---|---|---|---|---|---|---|---|---|
| DL-UL | point | Subframe index | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 2 above, ‘D’ denotes a DL subframe, ‘U’ denotes a UL subframe, and ‘S’ denotes a special subframe. Upon receiving the DL-UL configuration from the BS, the UE can know which subframe is the DL subframe, the UL subframe, or the special subframe according to the DL-UL configuration of the radio frame.

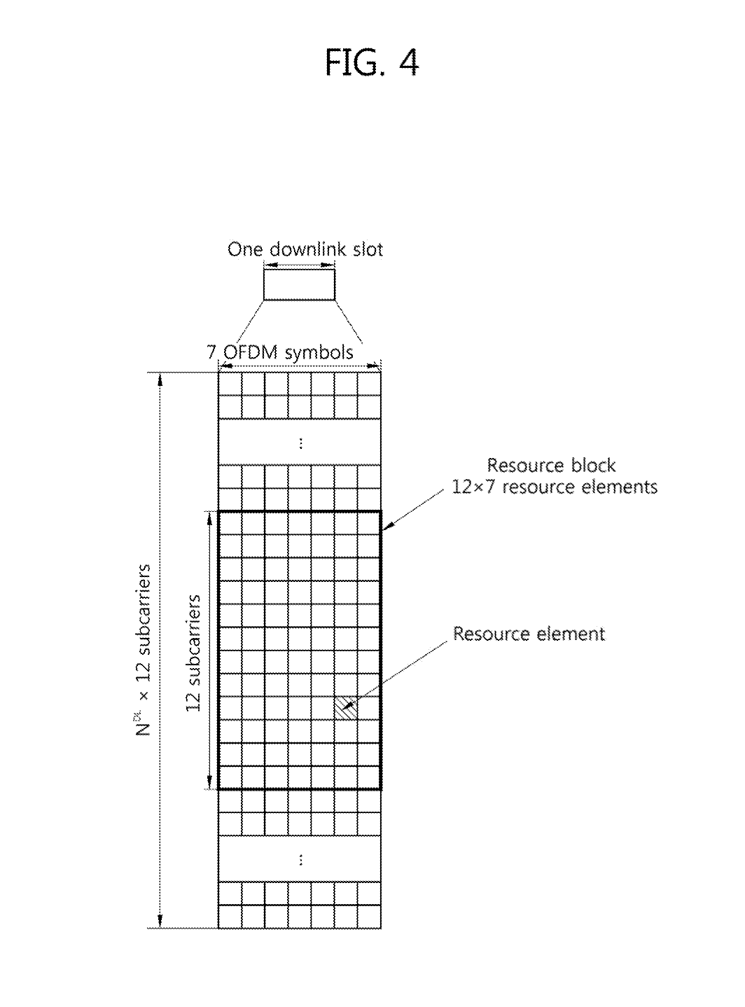

FIG. 4 shows an example of a resource grid for one DL slot.

Referring to FIG. 4, the DL slot includes a plurality of OFDM symbols in a time domain, and includes N_{RB} resource blocks (RBs) in a frequency domain. The RB includes one slot in the time domain in a unit of resource allocation, and includes a plurality of consecutive subcarriers in the frequency domain. The number N_{RB} of RBs included in the DL slot depends on a DL transmission bandwidth configured in a cell. For example, in the LTE system, N_{RB} may be any one value in the range of 6 to 110. A structure of a UL slot may be the same as the aforementioned structure of the DL slot.

Each element on the resource grid is referred to as a resource element (RE). The RE on the resource grid can be identified by an index pair (k,l) within the slot. Herein, k (k=0, . . . , N_{RB}×12−1) denotes a subcarrier index in the frequency domain, and l (l=0, . . . , 6) denotes an OFDM symbol index in the time domain.

Although it is described in FIG. 4 that one RB consists of 7 OFDM symbols in the time domain and 12 subcarriers in the frequency domain and thus includes 7×12 REs, this is for exemplary purposes only. Therefore, the number of OFDM symbols and subcarriers in the RB are not limited thereto. The number of OFDM symbols and the number of subcarriers may change variously depending on a CP length, a frequency spacing, etc. The number of subcarriers in one OFDM symbol may be any one value selected from 128, 256, 512, 1024, 1536, and 2048.

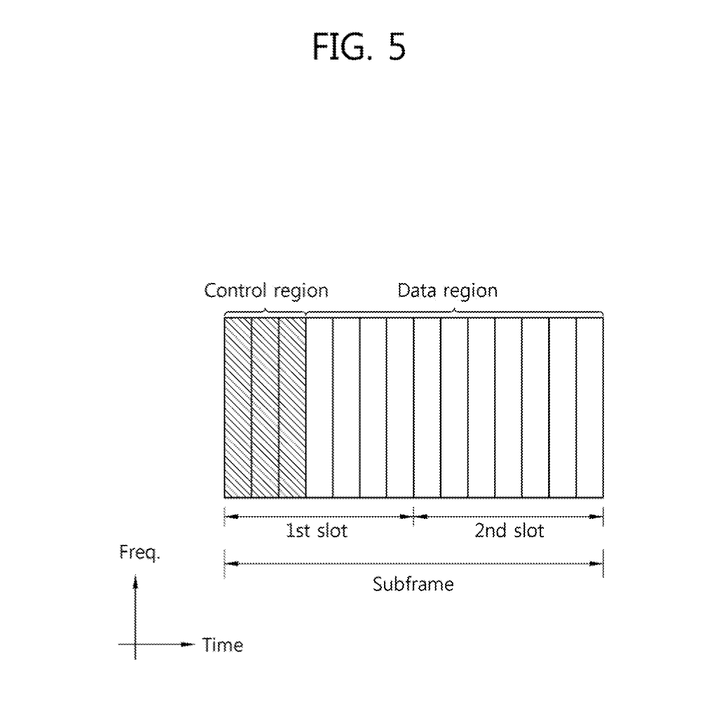

FIG. 5 shows a structure of a DL subframe.

The subframe includes two consecutive slots. A maximum of three OFDM symbols located in a front portion of a 1^{st} slot in the DL subframe correspond to a control region to which a physical downlink control channel (PDCCH) is allocated. The remaining OFDM symbols correspond to a data region to which a physical downlink shared channel (PDSCH) is allocated. Herein, the control region includes 3 OFDM symbols for exemplary purposes only.

Control channels such as a physical downlink control channel (PDCCH), a physical control format indicator channel (PCFICH), a physical hybrid automatic repeat request (HARQ) indicator channel (PHICH), etc., can be allocated to the control region. A UE can read data information transmitted through the data channel by decoding control information transmitted through the PDCCH. The PDCCH will be described below in detail. The number of OFDM symbols included in the control region of the subframe can be known by using the PCFICH. The PHICH carries a hybrid automatic repeat request (HARQ) acknowledgement (ACK)/negative-acknowledgment (NACK) signal in response to the UL transmission. The PDSCH can be allocated to the data region.

[PDCCH Structure]

A control region consists of a logical control channel element (CCE) stream which is a plurality of CCEs. A CCE corresponds to a plurality of resource element groups (REGs). For example, the CCE may correspond to 9 REGs. The REG is used to define mapping of a control channel to a resource element. For example, one REG may consist of four resource elements. The CCE stream denotes a set of all CCEs constituting the control region in one subframe.

A plurality of PDCCHs may be transmitted in the control region. The PDCCH is transmitted on an aggregation of one or several consecutive CCEs. A PDCCH format and the number of available PDCCH bits are determined according to the number of CCEs constituting the CCE aggregation. Hereinafter, the number of CCEs used for PDCCH transmission is referred to as a CCE aggregation level. In addition, the CCE aggregation level is a CCE unit for searching for the PDCCH. A size of the CCE aggregation level is defined by the number of consecutive CCEs. For example, the CCE aggregation level may be defined as a specific number of CCEs, where the specific number is selected from {1, 2, 4, 8}.

Table 3 below shows examples of the PDCCH format and the number of available PDCCH bits according to the CCE aggregation level.

TABLE 3

| PDCCH | CCE aggregation | Number of | Number of |
|---|---|---|---|
| format | level | REGs | PDCCH bits |
| 0 | 1 | 9 | 72 |
| 1 | 2 | 18 | 144 |
| 2 | 4 | 36 | 288 |
| 3 | 8 | 72 | 576 |

Control information transmitted through the PDCCH is referred to as downlink control information (hereinafter, DCI). The DCI transmits UL scheduling information (called a UL grant), DL scheduling information (called a DL grant), a UL power control command, control information for paging, control information for indicating a random access channel (RACH) response, etc.

The DCI can be transmitted with a specific format, and its usage can be defined according to each DCI format. For example, the usage of the DCI format can be classified as shown in Table 4 below.

TABLE 4

| DCI format | Contents |
|---|---|
| DCI format 0 | It is used for PUSCH scheduling. |
| DCI format 1 | It is used for scheduling of one PDSCH codeword. |
| DCI format 1A | It is used for compact scheduling and random access |
| | process of one PDSCH codeword. |
| DCI format 1B | It is used in simple scheduling of one PDSCH |
| | codeword having precoding information. |
| DCI format 1C | It is used for very compact scheduling of one PDSCH |
| | codeword. |
| DCI format 1D | It is used for simple scheduling of one PDSCH |
| | codeword having precoding and power offset |
| | information. |
| DCI format 2 | It is used for PDSCH scheduling of UEs configured |
| | to a closed-loop spatial multiplexing mode. |
| DCI format 2A | It is used for PDSCH scheduling of UEs configured |
| | to an open-loop spatial multiplexing mode. |
| DCI format 3 | It is used for transmission of a TPC command of a |
| | PUCCH and a PUSCH having a 2-bit power adjustment. |
| DCI format 3A | It is used for transmission of a TPC command of a |
| | PUCCH and a PUSCH having a 1-bit power adjustment. |
| DCI format 4 | It is used for PUSCH scheduling in one UL cell in a |
| | multi-antenna Tx mode. |

The PDCCH can be generated through the following process. A BS attaches a cyclic redundancy check (CRC) for error detection to DCI to be transmitted to a UE. The CRC is masked with an identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message transmitted through a paging channel (PCH), a paging indicator identifier (e.g., paging-RNTI (P-RNTI)) may be masked to the CRC. If the PDCCH is for system information transmitted through a DL-SCH, a system information identifier (e.g., system information-RNTI (SI-RNTI)) may be masked to the CRC. To indicate a random access response that is a response for transmission of a random access preamble of the UE, a random access-RNTI (RA-RNTI) may be masked to the CRC. When the C-RNTI is used, the PDCCH carries control information for a corresponding specific UE. When other RNTIs are used, the PDCCH carries common control information received by all UEs in a cell.

Thereafter, channel coding is performed on the CRC-attached control information to generate coded data. Then, rate matching is performed according to a CCE aggregation level assigned to the PDCCH format. Thereafter, the coded data is modulated to generate modulation symbols. The number of modulation symbols constituting one PDCCH may differ depending on a CCE aggregation level (i.e., one value selected from 1, 2, 4, and 8). The modulation symbols are mapped to physical resource elements (REs) (i.e., CCE to RE mapping).

In the 3GPP LTE, the UE uses blind decoding for PDCCH detection. The blind decoding is a scheme in which a desired identifier is de-masked from a CRC of a received PDCCH (referred to as a candidate PDCCH) and a CRC error is checked to determine whether the PDCCH is its own control channel. The blind decoding is performed because the UE cannot know about a specific position in a control region in which its PDCCH is transmitted and about a specific CCE aggregation or DCI format used for PDCCH transmission.

As described above, a plurality of PDCCHs can be transmitted in one subframe. The UE monitors the plurality of PDCCHs in every subframe. Herein, monitoring is an operation in which the UE attempts PDCCH decoding according to a PDCCH format.

The 3GPP LTE uses a search space to reduce an overload caused by blind decoding. The search space can also be called a monitoring set of a CCE for the PDCCH. The UE monitors the PDCCH in the search space.

The search space is classified into a common search space (CSS) and a UE-specific search space (USS). The CSS is a space for searching for a PDCCH having common control information and consists of 16 CCEs indexed with 0 to 15. The CSS supports a PDCCH having a CCE aggregation level of {4, 8}. However, a PDCCH (e.g., DCI formats 0, 1A) for carrying UE-specific information can also be transmitted in the CSS. The USS supports a PDCCH having a CCE aggregation level of {1, 2, 4, 8}.

A start point of the search space is defined differently in the CSS and the USS. Although a start point of the CSS is fixed irrespective of a subframe, a start point of the USS may vary in every subframe according to a UE identifier (e.g., C-RNTI), a CCE aggregation level, and/or a slot number in a radio frame. If the start point of the USS exists in the CSS, the USS and the CSS may overlap with each other.

In a CCE aggregation level Lε{1,2,3,4}, a search space S^{(L)}ₖ is defined as a set of candidate PDCCHs. A CCE corresponding to a candidate PDCCH m of the search space S^{(L)}ₖ is given by Equation 1 below.

L·{(Yₖ+m)mod └N_{CCE,k}/L┘}+i [Equation 1]

Herein, i=0, 1, . . . , L−1, m=0, . . . , M^{(L)}−1, and N_{CCE,k} denotes the total number of CCEs that can be used for PDCCH transmission in a control region of a subframe k. The control region includes a set of CCEs numbered from 0 to N_{CCE,k}−1. M^{(L)} denotes the number of candidate PDCCHs in a CCE aggregation level L of a given search space. In the CSS, Yₖ is set to 0 with respect to two aggregation levels L=4 and L=8. In the USS of the CCE aggregation level L, a variable Yₖ is defined by Equation 2 below.

Yₖ=(A·Yₖ₋₁)mod D [Equation 2]

Herein, Y₋₁=n_{RNTI}≠0, A=39827, D=65537, k=floor(nₛ/2), and nₛ denotes a slot number in a radio frame.

Table 5 below shows the number of candidate PDCCHs in the search space.

TABLE 5

| | | The number of | The number of |
|---|---|---|---|
| PDCCH | The number of | candidate PDCCHs | candidate PDCCHs |
| format | CCEs | in CSS | in USS |
| 0 | 1 | — | 6 |
| 1 | 2 | — | 6 |
| 2 | 4 | 4 | 2 |
| 3 | 8 | 2 | 2 |

A DL transmission mode between a BS and a UE can be classified into 9 types as follows.

Transmission mode 1: A mode in which precoding is not performed (a single antenna port transmission mode).

Transmission mode 2: A transmission mode that can be used in 2 or 4 antenna ports using SFBC (transmit diversity).

Transmission mode 3: An open-loop mode in which rank adaptation based on RI feedback is possible (open-loop spatial multiplexing). The transmit diversity is applicable when a rank is 1. A great delay CDD can be used when the rank is greater than 1.

Transmission mode 4: A mode in which precoding feedback supporting dynamic rank adaptation is applied (closed-loop spatial multiplexing).

Transmission mode 5: Multi-user MIMO

Transmission mode 6: Closed-loop rank-1 precoding

Transmission mode 7: A transmission mode in which a UE-specific reference signal is used.

Transmission mode 8: Dual-layer transmission using antenna ports 7 and 8, or single-antenna port transmission using the antenna port 7 or the antenna port 8 (dual-layer transmission).

Transmission mode 9: Up to 8-layer transmission using antenna ports 7 to 14.

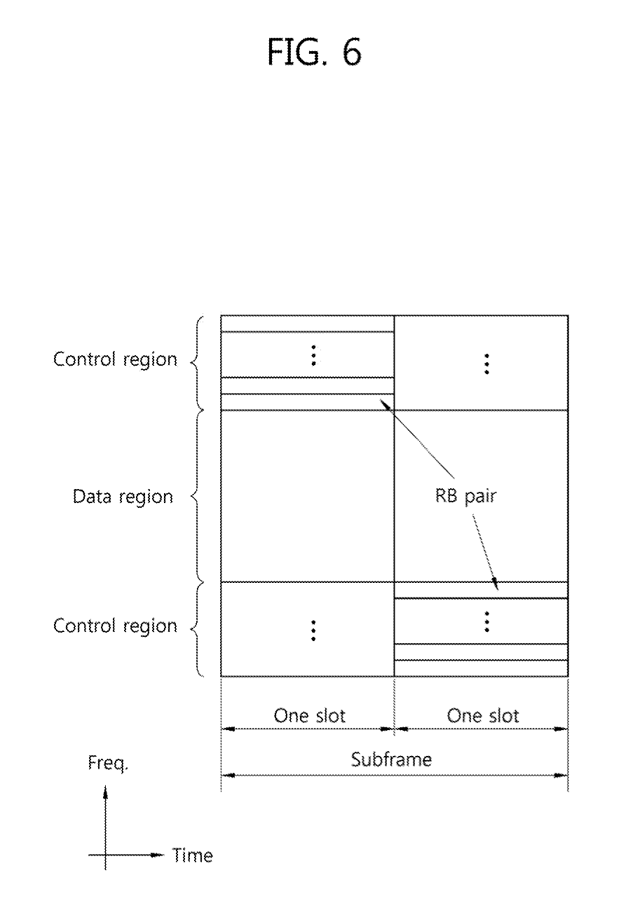

FIG. 6 shows a structure of a UL subframe.

Referring to FIG. 6, the UL subframe can be divided into a control region and a data region in a frequency domain. A physical uplink control channel (PUCCH) for transmitting UL control information is allocated to the control region. A physical uplink shared channel (PUSCH) for transmitting data (optionally, control information can be transmitted together) is allocated to the data region. According to a configuration, the UE may simultaneously transmit the PUCCH and the PUSCH, or may transmit any one of the PUCCH and the PUSCH.

The PUCCH for one UE is allocated in an RB pair in a subframe. RBs belonging to the RB pair occupy different subcarriers in each of a 1^{st} slot and a 2^{nd} slot. A frequency occupied by the RBs belonging to the RB pair allocated to the PUCCH changes at a slot boundary. This is called that the RB pair allocated to the PUCCH is frequency-hopped in a slot boundary. By transmitting UL control information over time through different subcarriers, a frequency diversity gain can be obtained.

A hybrid automatic repeat request (HARQ) acknowledgement (ACK)/non-acknowledgment (NACK) and channel status information (CSI) indicating a DL channel status (e.g., channel quality indicator (CQI), a precoding matrix index (PMI), a precoding type indicator (PTI), a rank indication (RI), etc.) can be transmitted through the PUCCH. Periodic CSI can be transmitted through the PUCCH.

The PUSCH is mapped to an uplink shared channel (UL-SCH) which is a transport channel. UL data transmitted through the PUSCH may be a transport block which is a data block for the UL-SCH transmitted during a TTI. The transport block may include user data. Alternatively, the UL data may be multiplexed data. The multiplexed data may be obtained by multiplexing CSI and a transport block for the UL-SCH. Examples of the CSI multiplexed to the data may include a CQI, a PMI, an RI, etc. Alternatively, the UL data may consist of only CSI. Periodic or aperiodic CSI can be transmitted through the PUSCH.

Now, semi-persistent scheduling (SPS) will be described.

In LTE, a higher-layer signal such as radio resource control (RRC) can be used to report a UE about specific subframes in which semi-persistent transmission/reception is performed. Examples of a parameter given as the higher layer signal may be a subframe period and an offset value.

The UE recognizes semi-persistent transmission through RRC signaling, and thereafter performs or releases SPS PDSCH reception or SPS PUCCH transmission upon receiving an activation or release signal of SPS transmission through a PDCCH. That is, in a case where the activation or release signal is received through the PDCCH instead of directly performing SPS transmission even if SPS scheduling is assigned through RRC signaling, the UE applies a frequency resource (resource block) based on resource block allocation and a modulation and coding rate based on MCS information, which are designated in the PDCCH, and thus performs SPS transmission/reception in a subframe corresponding to an offset value and a subframe period assigned through RRC signaling.

If an SPS release signal is received through the PDCCH, SPS transmission/reception is suspended. Upon receiving a PDCCH including the SPS activation signal, the suspended SPS transmission/reception is resumed by using a frequency resource, MCS, etc., designated in the PDCCH.

The PDCCH for the SPS configuration/release can be called an SPS allocation PDCCH, and a PDCCH for a normal PUSCH can be called a dynamic PDCCH. The UE can validate whether the PDCCH is the SPS allocation PDCCH when the following conditions are satisfied, that is, 1) CRC parity bits derived from a PDCCH payload must be scrambled with an SPS C-RNTI, and 2) a value of a new data indicator field must be ‘0’. In addition, when each field value of a PDCCH is determined as shown in the field value of Table 6 below with respect to each DCI format, the UE recognizes DCI information of the PDCCH as SPS activation or release.

TABLE 6

| | DCI format | DCI format | DCI format |
|---|---|---|---|
| | 0 | 1/1A | 2/2A/2B/2C |
| TPC command for | set to ‘00’ | N/A | N/A |
| scheduled PUSCH | | | |
| Cyclic shift DM | set to ‘000’ | N/A | N/A |
| RS | | | |
| Modulation and | MSB is set | N/A | N/A |
| coding scheme and | to ‘0’ | | |
| redundancy | | | |
| version | | | |
| HARQ process | N/A | FDD: set to ‘000’ | FDD: set to ‘000' |
| number | | TDD: set to | TDD: set to |
| | | ‘0000’ | ‘0000’ |
| Modulation and | N/A | MSB is set to ‘0’ | For the enabled |
| coding scheme | | | transport block: |
| | | | MSB is set to ‘0’ |
| Redundancy | N/A | set to ‘00’ | For the enabled |
| version | | | transport block: |
| | | | set to ‘00’ |

Table 6 above shows an example of a field value of an SPS allocation PDCCH for validating SPS activation.

TABLE 7

| | DCI format 0 | DCI format 1A |
|---|---|---|
| TPC command for scheduled | set to ‘00’ | N/A |
| PUSCH | | |
| Cyclic shift DM RS | set to ‘000’ | N/A |
| Modulation and coding | set to ‘11111’ | N/A |
| scheme and redundancy | | |
| version | | |
| Resource block assignment | Set to all ‘1’s | N/A |
| and hopping resource | | |
| allocation | | |
| HARQ process number | N/A | FDD: set to ‘000’ |
| | | TDD: set to ‘0000’ |
| Modulation and coding | N/A | set to ‘11111’ |
| scheme | | |
| Redundancy version | N/A | set to ‘00’ |
| Resource block assignment | N/A | Set to all ‘1’s |

Table 7 above shows an example of a field value of an SPS release PDCCH for validating SPS release.

Now, a carrier aggregation system will be described.

[Carrier Aggregation System]

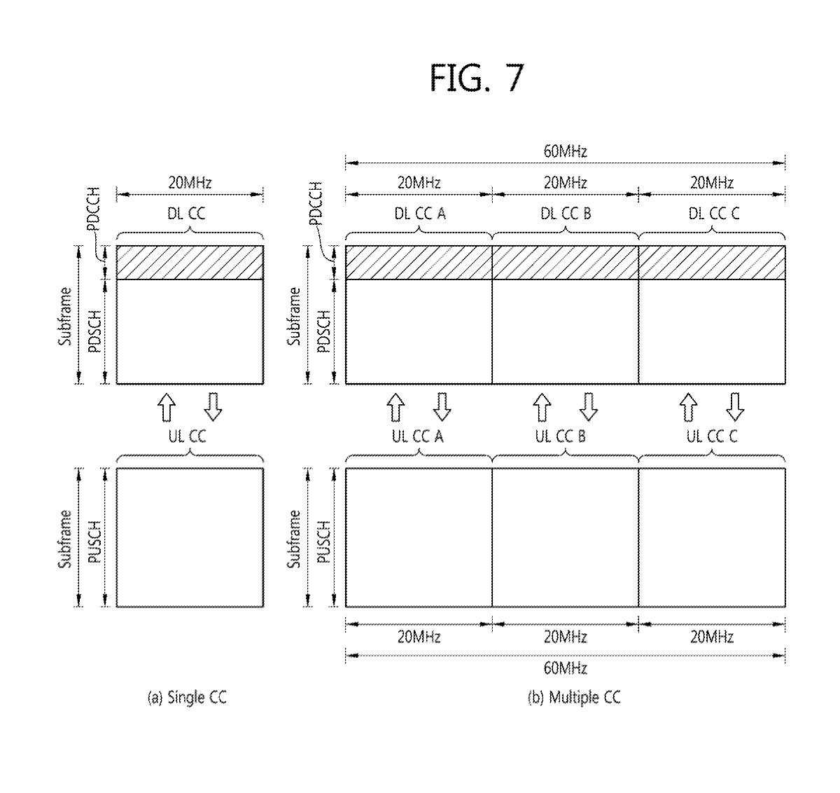

FIG. 7 shows an example of comparing a carrier aggregation system with the conventional single-carrier system.

Referring to FIG. 7, the single-carrier system supports only one carrier for a UE in an uplink (UL) and a downlink (DL). Although the carrier may have various bandwidths, only one carrier is assigned to the UE. Meanwhile, the multiple-carrier system can assign multiple CCs, i.e., DL CCs A to C and UL CCs A to C, to the UE. For example, three 20 MHz CCs can be assigned to the UE to allocate a 60 MHz bandwidth.

The carrier aggregation system can be divided into a contiguous carrier aggregation system in which carriers to be aggregated are contiguous to each other and a non-contiguous carrier aggregation system in which carriers are separated from each other. Hereinafter, when it is simply called the carrier aggregation system, it should be interpreted such that both cases of contiguous CCs and non-contiguous CCs are included.

A CC which is a target when aggregating one or more CCs can directly use a bandwidth that is used in the legacy system in order to provide backward compatibility with the legacy system. For example, a 3GPP LTE system can support a bandwidth of 1.4 MHz, 3 MHz, 5 MHz, 10 MHz, 15 MHz, and 20 MHz, and a 3GPP LTE-A system can configure a wideband of 20 MHz or higher by using only the bandwidth of the 3GPP LTE system. Alternatively, the wideband can be configured by defining a new bandwidth without having to directly use the bandwidth of the legacy system.

A system band of a wireless communication system is divided into a plurality of carrier frequencies. Herein, the carrier frequency implies a center frequency of a cell. Hereinafter, the cell may imply a DL frequency resource and a UL frequency resource. Alternatively, the cell may also imply a combination of a DL frequency resource and an optional UL frequency resource. In general, if carrier aggregation (CA) is not considered, UL and DL frequency resources may always exist in pair in one cell.

In order to transmit and receive packet data via a specific cell, the UE first has to complete a configuration of the specific cell. Herein, the configuration implies a state in which system information required for data transmission and reception for the cell is completely received. For example, the configuration may include an overall procedure that requires common physical layer parameters necessary for data transmission and reception, MAC layer parameters, or parameters necessary for a specific operation in an RRC layer. A cell of which configuration is complete is in a state capable of immediately transmitting and receiving a packet upon receiving only information indicating that packet data can be transmitted.

The cell in a state of completing its configuration can exist in an activation or deactivation state. Herein, the activation implies that data transmission or reception is performed or is in a ready state. The UE can monitor or receive a control channel (i.e., PDCCH) and a data channel (i.e., PDSCH) of an activated cell in order to confirm a resource (e.g., frequency, time, etc.) allocated to the UE.

The deactivation implies that data transmission or reception is impossible and measurement or transmission/reception of minimum information is possible. The UE can receive system information (SI) required to receive a packet from a deactivated cell. On the other hand, in order to confirm the resource (e.g., frequency, time, etc.) allocated to the UE, the UE does not monitor or receive a control channel (i.e., PDCCH) and a data channel (i.e., PDSCH) of the deactivated cell.

A cell can be classified into a primary cell, a secondary cell, and a serving cell.

The primary cell implies a cell that operates at a primary frequency. Further, the primary cell implies a cell in which the UE performs an initial connection establishment procedure or a connection re-establishment procedure with respect to the BS or a cell indicated as the primary cell in a handover procedure.

The secondary cell implies a cell that operates at a secondary frequency. Once an RRC connection is established, the secondary cell is used to provide an additional radio resource.

When carrier aggregation is not configured or when the UE cannot provide carrier aggregation, the serving cell is configured with the primary cell. If the carrier aggregation is configured, the term ‘serving cell’ indicates a cell configured for the UE, and can consist of a plurality of cells. One serving cell may consist of one DL CC or a pair of {DL CC, UL CC}. The plurality of serving cells can be configured with a set consisting of a primary cell and one or a plurality of cells among secondary cells.

A primary component carrier (PCC) denotes a CC corresponding to the primary cell. The PCC is a CC that establishes an initial connection (or RRC connection) with the BS among several CCs. The PCC serves for connection (or RRC connection) for signaling related to a plurality of CCs, and is a CC that manages UE context which is connection information related to the UE. In addition, the PCC establishes a connection with the UE, and thus always exists in an activation state when in an RRC connected mode. A DL CC corresponding to the primary cell is called a DL primary component carrier (DL PCC), and a UL CC corresponding to the primary cell is called a UL primary component carrier (UL PCC).

A secondary component carrier (SCC) implies a CC corresponding to the secondary cell. That is, the SCC is a CC allocated to the UE in addition to the PCC. The SCC is an extended carrier used by the UE for additional resource allocation or the like in addition to the PCC, and can operate either in an activation state or a deactivation state. A DL CC corresponding to the secondary cell is called a DL secondary CC (DL SCC), and a UL CC corresponding to the secondary cell is called a UL secondary CC (UL SCC).

The primary cell and the secondary cell have the following features.

First, the primary cell is used for PUCCH transmission. Second, the primary cell is always activated, whereas the secondary cell relates to a carrier which is activated/deactivated according to a specific condition. Third, when the primary cell experiences a radio link failure (RLF), RRC re-connection is triggered, whereas when the secondary cell experiences the RLF, the RRC re-connection is not triggered. Fourth, the primary cell can change by a handover procedure accompanied by a random access channel (RACH) procedure or security key modification. Fifth, non-access stratum (NAS) information is received through the primary cell. Sixth, the primary cell always consists of a pair of a DL PCC and a UL PCC. Seventh, for each UE, a different CC can be configured as the primary cell. Eighth, a procedure such as reconfiguration, adding, and removal of the primary cell can be performed by an RRC layer. When adding a new secondary cell, RRC signaling can be used for transmission of system information of a dedicated secondary cell.

Regarding a CC constructing a serving cell, a DL CC can construct one serving cell, or the DL CC can be connected to a UL CC to construct one serving cell. However, the serving cell is not constructed only with one UL CC.

Activation/deactivation of a CC is equivalent in concept to activation/deactivation of a serving cell. For example, if it is assumed that a serving cell 1 consists of a DL CC 1, activation of the serving cell 1 implies activation of the DL CC 1. If it is assumed that a serving cell 2 is configured by connecting a DL CC 2 and a UL CC 2, activation of the serving cell 2 implies activation of the DL CC 2 and the UL CC 2. In this sense, each CC can correspond to a cell.

The number of CCs aggregated between a downlink and an uplink may be determined differently. Symmetric aggregation is when the number of DL CCs is equal to the number of UL CCs. Asymmetric aggregation is when the number of DL CCs is different from the number of UL CCs. In addition, the CCs may have different sizes (i.e., bandwidths). For example, if 5 CCs are used to configure a 70 MHz band, it can be configured such as 5 MHz CC (carrier #0)+20 MHz CC (carrier #1)+20 MHz CC (carrier #2)+20 MHz CC (carrier #3)+5 MHz CC (carrier #4).

As described above, the carrier aggregation system can support a plurality of CCs, that is, a plurality of serving cells, unlike a single carrier system.

The carrier aggregation system can support cross-carrier scheduling. The cross-carrier scheduling is a scheduling method capable of performing resource allocation of a PDSCH transmitted by using a different carrier through a PDCCH transmitted via a specific CC and/or resource allocation of a PUSCH transmitted via another CC other than a CC basically linked to the specific CC. That is, the PDCCH and the PDSCH can be transmitted through different DL CCs, and the PUSCH can be transmitted via a UL CC other than a UL CC linked to a DL CC on which a PDCCH including a UL grant is transmitted. As such, in a system supporting the cross-carrier scheduling, a carrier indicator is required to report a specific DL CC/UL CC used to transmit the PDSCH/PUSCH for which the PDCCH provides control information. A field including the carrier indicator is hereinafter called a carrier indication field (CIF).

The carrier aggregation system supporting the cross-carrier scheduling may include a CIF in the conventional downlink control information (DCI) format. In a system supporting the cross-carrier scheduling, e.g., an LTE-A system, the CIF is added to the conventional DCI format (i.e., the DCI format used in LTE) and thus the number of bits can be extended by 3 bits, and the PDCCH structure can reuse the conventional coding scheme, resource allocation scheme (i.e., CCE-based resource mapping), etc.

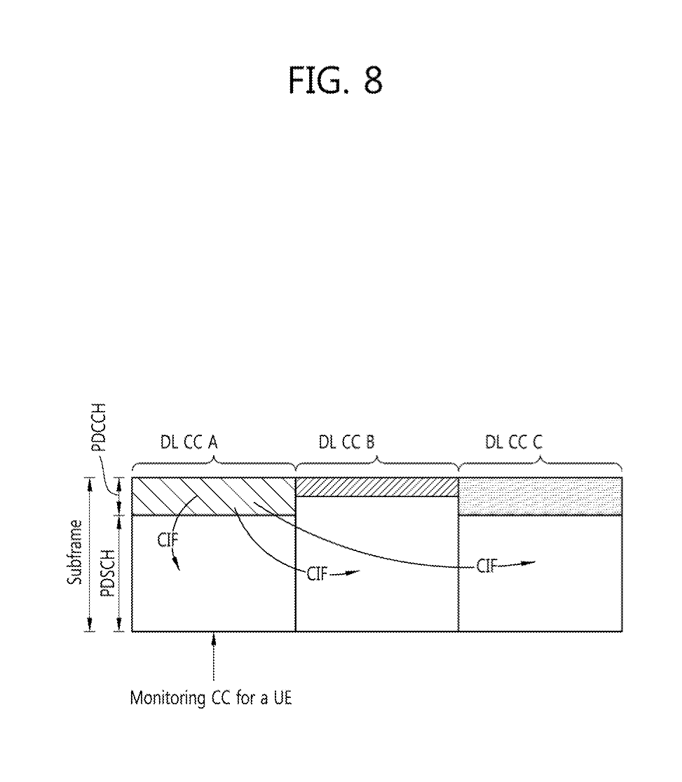

FIG. 8 shows a subframe structure for cross-carrier scheduling in a carrier aggregation system.

Referring to FIG. 8, a BS can determine a PDCCH monitoring DL CC set. The PDCCH monitoring DL CC set consists of some DL CCs among all aggregated DL CCs. When the cross-carrier scheduling is configured, a UE performs PDCCH monitoring/decoding only for a DL CC included in the PDCCH monitoring DL CC set. In other words, the BS transmits a PDCCH for a to-be-scheduled PDSCH/PUSCH only via a DL CC included in the PDCCL monitoring DL CC set. The PDCCH monitoring DL CC set can be determined in a UE-specific, UE group-specific, or cell-specific manner.

In the example of FIG. 8, 3 DL CCs (i.e., DL CC A, DL CC B, DL CC C) are aggregated, and the DL CC A is determined as the PDCCH monitoring DL CC. The UE can receive a DL grant for a PDSCH of the DL CC A, the DL CC B, and the DL CC C through the PDCCH. A CIF may be included in DCI transmitted through the PDCCH of the DL CC A to indicate a specific DL CC for which the DCI is provided.

Now, a method for scheduling in a carrier aggregation system will be described according to an embodiment of the present invention.

An FDD frame (type 1) and a TDD frame (type 2) are present in an LTE system. In an LTE-A Rel-10 system, although a plurality of serving cells can be allocated to one UE and transmission and reception can be achieved through a plurality of serving cells, a UE can use only the same type of frames in the plurality of serving cells. In other words, only the serving cells using the same type of frames can be allocated to the same UE. However, due to a necessity of aggregating various idle frequency bands, aggregation between serving cells using different types of frames is considered in a future communication system. Under this premise, there is a need for a scheduling method in a carrier aggregation system.

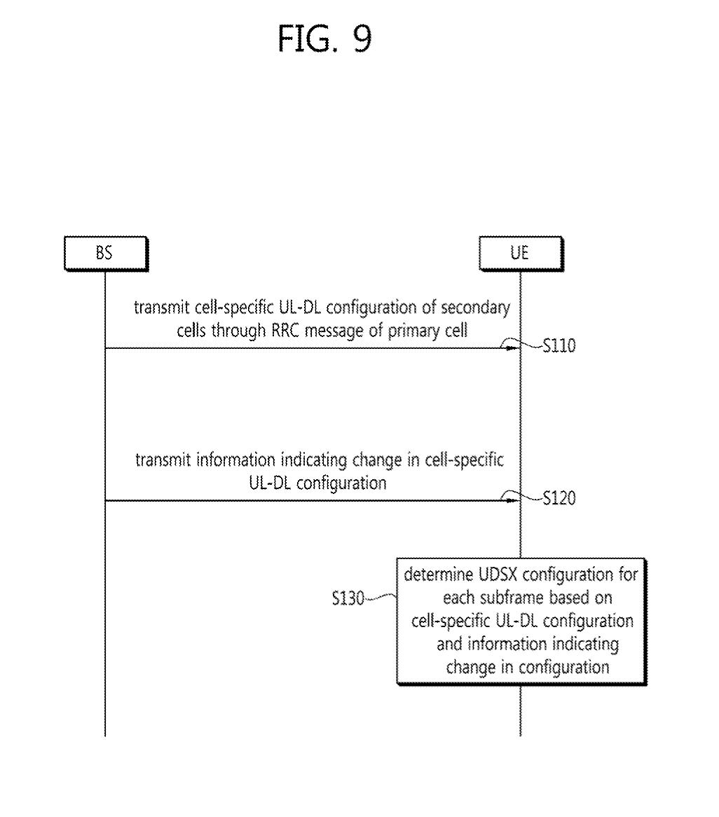

FIG. 9 shows a method for scheduling between a BS and a UE according to an embodiment of the present invention.

Referring to FIG. 9, the BS transmits a UL-DL configuration of secondary cells by using an RRC message of a primary cell (step S110). It is assumed herein that the BS additionally aggregates the secondary cells in a state in which the UE is connected to the primary cell. If an additional secondary cell is aggregated in a state in which the BS aggregates a primary cell and a secondary cell, an RRC message for a UL-DL configuration of the additional secondary cell may be transmitted in pre-aggregated cells.

The primary cell may be a serving cell which uses an FDD frame, and the secondary cells may be at least one serving cell which uses a TDD frame. Alternatively, all cells may be configured with TDD, and in this case, a UL-DL configuration may be different between the primary cell and the secondary cell. A UL-DL configuration of an RRC message is configuration information indicating a specific type of subframe, among a downlink subframe (D), an uplink subframe (U), and a special subframe (S), to which each subframe in one TDD frame belongs as exemplified in Table 2 above. The UL-DL configuration of the RRC message may be given to all secondary cells allocated to the UE, for each secondary cell or each secondary cell group. That is, the UL-DL configuration of the RRC message may be configured differently for each secondary cell, or may be configured equally for at least two secondary cells.

The UL-DL configuration of the RRC message may be the same information as a UL-DL configuration to be broadcast as system information in each secondary cell. A UL-DL configuration which is broadcast in each secondary cell is called a cell-specific UL-DL configuration. The UL-DL configuration included in the RRC message may be the same as the cell-specific UL-DL configuration. If a secondary cell is additionally aggregated in a state in which a UE is connected to the primary cell through a communication channel (e.g., an RRC connected state), receiving of a UL-DL configuration for each subframe of the secondary cell by using an RRC message transmitted through the primary cell is more effective than receiving of a cell-specific UL-DL configuration through the secondary cell. This is because system information of the secondary cell needs to be persistently monitored if the cell-specific UL-DL configuration must be received through the secondary cell.

The BS transmits information indicating a change in a cell-specific UL-DL configuration of the secondary cell through the primary cell (step S120). For example, the information indicating the change in the cell-specific UL-DL configuration of the secondary cell may be a UE-specific UL-DL configuration. The UE-specific UL-DL configuration implies a UL-DL configuration in a TDD frame which applies only to a specific UE. In particular, a UE-specific UL-DL configuration for a serving cell that must receive system information from another serving cell is preferably transmitted together with a cell-specific UL-DL configuration. The UE-specific UL-DL configuration can be commonly applied to all serving cells allocated to the UE.

The UE performs a ‘UDSX’ configuration on each subframe of the secondary cells on the basis of the cell-specific UL-DL configuration and the information indicating the change in the cell-specific UL-DL configuration (step S130). Herein, the UDSX configuration implies that each of subframes of the secondary cells is configured to an uplink subframe (U), a downlink subframe (D), a special subframe (S), or a unused subframe (X). The UE can communicate with the BS by performing the UDSX configuration of each subframe.

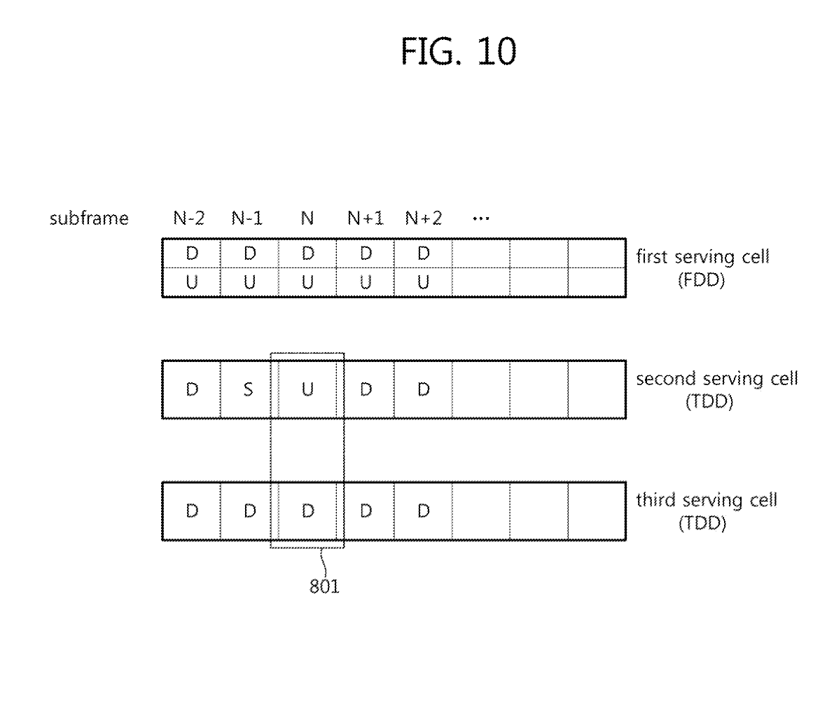

FIG. 10 shows an example of an unused subframe.

Referring to FIG. 10, a first serving cell using an FDD frame and second and third serving cells using a TDD frame can be allocated to a UE. Herein, the first serving cell may be a primary cell, and the second and third serving cells may be secondary cells. According to a cell-specific UL-DL configuration on secondary cells (i.e., the second serving cell and the third serving cell), a subframe #N of the second serving cell may be configured to U, and a subframe #N of the third serving cell may be configured to D. In this case, the subframe #N is an unused subframe 801. The UE may not use the unused subframe. A state of the unused subframe which is not used as described above is indicated by X to distinguish it from the existing subframes D, U, and S.

Although it is described in FIG. 10 that the unused subframe is generated because different serving cells have different cell-specific UL-DL configurations for example, the unused subframe may also be generated when a cell-specific UL-DL configuration which is configured for a single serving cell differs from a UE-specific UL-DL configuration for the single serving cell. That is, regarding a specific subframe of a secondary cell, an unused subframe may be generated in which a transmission direction based on a cell-specific UL-DL configuration does not coincide with a UE-specific UL-DL configuration.

The UL-DL configuration of the secondary cells using the TDD frame may be indicated, as described above, through a UL-DL configuration in a unit of subframe set in one frame (e.g., the UL-DL configuration of Table 2), and may also be indicated in a unit of subframe.

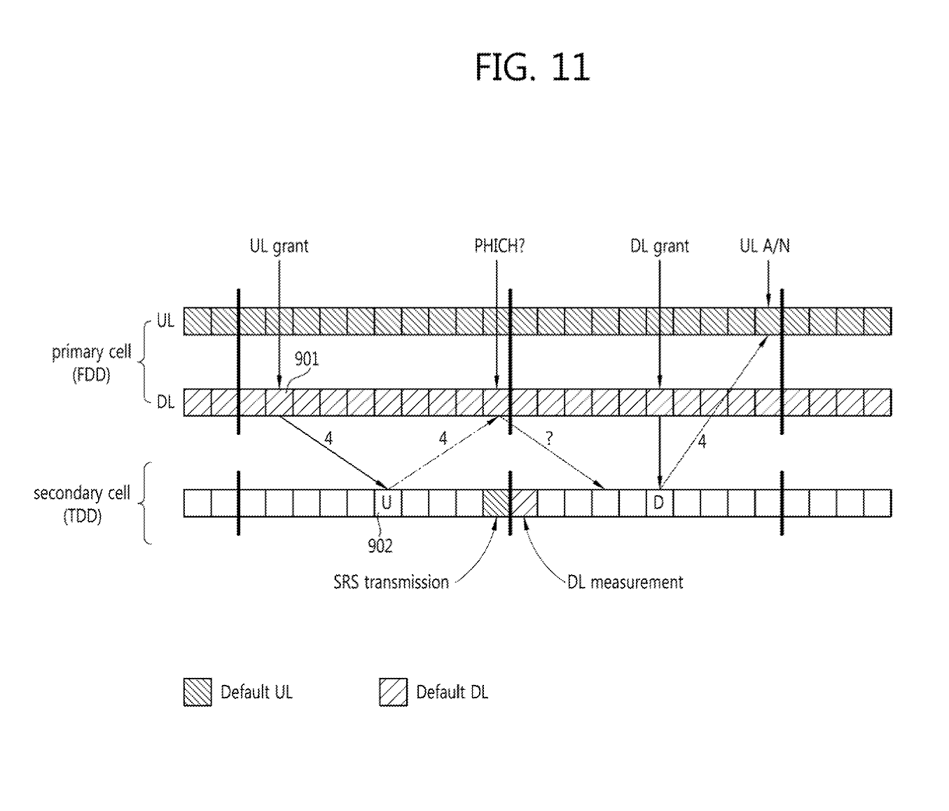

FIG. 11 shows an example of performing a UL-DL configuration of a secondary cell in a unit of subframe.

Referring to FIG. 11, a primary cell and a secondary cell can be allocated to a UE. In this case, the primary cell may use an FDD frame, and the secondary cell may be a TDD frame.

Preferably, the primary cell maintains backward compatibility for initial cell synchronization and initial access. On the contrary, it is not necessary for the secondary cell to maintain the backward compatibility. Therefore, in terms of a frequency band, the primary cell can be selected from licensed bands of the conventional wireless communication system, and the secondary cell can use an unlicensed band.

Each subframe of the secondary cell may be a flexible subframe which is not determined to any one of subframes U, D, S, and X. In this case, the BS may transmit a PDCCH to the UE (this is called UE-specific L1 signaling) through any subframe 901 of the primary cell. In case of using the UE-specific L1 signaling, the UE can determine a UDSX configuration of a flexible subframe 902 according to whether it is an uplink or a downlink which is scheduled by a DCI format detected through a PDCCH connected to the flexible subframe 902.

That is, if the DCI format indicates a UL grant which triggers the use of a UL subframe or indicates PUSCH transmission caused by a PHICH NACK response, it is recognized that the flexible subframe 902 is used as the UL subframe. On the other hand, if the DCI format indicates a DL grant which triggers the use of a DL subframe caused by the DCI format, it is recognized that the flexible subframe 902 is used as the DL subframe. The flexible subframe and its related UL grant timing and DL grant timing may be configured independently from each other.

Further, FIG. 11 shows a case where a primary cell has a control channel including a grant, and a secondary cell has a data channel. That is, it is exemplified a case where the control channel and the data channel exist in different frequency bands or serving cells. However, the present invention is not limited thereto, and thus can also be applied to a case where the flexible subframe and its related UL grant/DL grant exist in the same serving cell.

Some parts of the flexible subframe 902, that is, a specific number of first parts of symbols or a first slot of the subframe 902, may be used by being fixed for DL or UL, and the remaining parts, i.e., a specific number of last parts of symbols or a second slot of the subframe, may be configured selectively for UL or DL.

The control channel (e.g., PDCCH, PHICH, PUCCH, etc.) is preferably transmitted through the primary cell. Even if the primary cell uses a TDD frame, the control channel is also preferably transmitted in the primary cell in which each of subframes is designated/fixed to D or U as a default value.

If a gap is required to avoid a collision with UL transmission among subframes configured to D subframes in the TDD frame of the secondary cell, it may operate as an S subframe. In addition, in case of a secondary cell using an unlicensed band, even if the UE receives a UL grant, the UE may not transmit a PUSCH if it is determined, through secondary cell sensing, that a corresponding serving cell is interfered or is used by another UE.

If the UE receives information indicating a UDSX configuration (e.g., a UL grant, a DL grant, an indicator directly indicating the ULSX configuration, etc.) in a subframe #n of a primary cell, a subframe of a secondary cell to which the information indicating the UDSX configuration is applied may be a subframe #n+k. That is, an offset value k can be used so that a subframe (of a primary cell) in which the information indicating the UDSX configuration is received is different from a subframe (of a secondary cell) to which the information is applied. By using the offset value, a UL/DL change in the subframe of the secondary cell can be achieved smoothly. The value k may be a predetermined or signaled. In addition, the value k may be commonly applied to D, U, and S or may be applied differently according to D, U, and S.

In addition, if a specific subframe of the secondary cell is indicated by U, a subframe located before the subframe indicated by U may be configured to S. In this case, the value k must be greater than or equal to 1. If consecutive subframes are indicated by U in the secondary cell, a subframe located before U subframes except for a first U subframe may not be configured to S.

In addition, if two consecutive subframes of the secondary cell are indicated by {D, U} (or {U, D}) in that order, scheduling may be restricted in at least one of the two consecutive subframes. If the consecutive subframes of the secondary cell are indicated by {D, U} (or {U, D}), the UE may recognize that an error occurs and configure a subframe located before the U subframe to a blank subframe or X.

It is assumed that k=4 for example. If a subframe #4 of a secondary cell is scheduled to U in a subframe #0 of a primary cell, a subframe #3 of the secondary cell may not be subjected to blind decoding or may be ignored.

If the two consecutive subframes of the secondary cell are configured to {D, U} and/or {U, D} and thus a change occurs between UL and DL, the use of some OFDM symbols of a subframe at which the change starts may be restricted to avoid interference. That is, a change gap can be configured. Data to be transmitted in the OFDM symbol may be subjected to rate matching or may be punctured. The number of OFDM symbols of which use is restricted may be determined to a predetermined value or may be determined according to a value DwPTS or UpPTS. Alternatively, the BS may report the number of the OFDM symbols to the UE by using system information and L1/L2/L3 signaling. In addition, the use of the OFDM symbol may be selectively restricted such that the restriction is applied only when configured to {D, U} or only when configured to {U, D}.

Alternatively, if the two consecutive subframes of the secondary cell are configured to {D, U} and/or {U, D}, the use of some OFDM symbols of the subframes may be restricted in every case to avoid interference.

The present invention is not restricted to a case where all subframes of the secondary cell are flexible subframes. That is, some subframes of the secondary cell may be designated to D (or U) as a default value. For example, in FIG. 11, some subframes of the secondary cell can be designated to D as a default value and thus can be used in DL measurement. In addition, some subframes of the secondary cell may be designated to U as a default value and thus can be used in transmission of sounding reference signal (SRS) and periodic CSI.

As such, if the some subframes of the secondary cell are designated to D (or U) as a default value, a UDSX configuration may be achieved only for the remaining subframes through a primary cell.

Alternatively, the flexible subframe may be designated to D (or U) as a default value, and a UDSX configuration may change through the primary cell. For example, if the UE fails to receive specific signaling, the flexible subframe may be recognized as a subframe configured to D as a default value, and if the UE receives the specific signaling, the flexible subframe may be changed to a subframe configured to U. In this case, the subframe configured to D as the default value can be changed to U only during a duration of N subframes, and if the duration of N subframes is over, can be restored to D configured as the default value. The value N may be predetermined or may be signaled using RRC.

If there is a no subframe configured as a default value in a TDD frame of the secondary cell, the BS may trigger SRS transmission and CSI measurement to the UE.

In addition, in the TDD frame of the secondary cell, it can be restricted such that CQI measurement or periodic CQI transmission and periodic SRS transmission are achieved only in a subframe fixed as a default value. CQI is used in a board sense, and has the same meaning as channel state information (CSI).

A U subframe for CSI reporting for a serving cell C must be configured by considering a preparation time for measuring and reporting CSI of the serving cell C. For example, an offset of n_{CQI}_{_{—}}_{REF,MIN} (e.g., 4) subframes may have to be given between a D subframe which is a target of CSI measurement in the serving cell C and a U subframe for transmitting CSI for the D subframe. In this case, a U subframe for CSI reporting is configured to have an offset corresponding to more than n_{CQI}_{_{—}}_{REF,MIN} subframes from the D subframe which is the target of CSI measurement. In other words, the BS performs a configuration such that a valid D subframe located before a U subframe for CSI reporting is a CSI measurement target subframe.

The valid D subframe can be determined as follows.

1) A subframe fixed to have a default value D in a TDD frame of a secondary cell. The subframe having the default value D may be a subframe configured not to a subframe determined dynamically by a primary cell but to a D subframe configured by a semi-persistent configuration. In case of a UE operating with half-duplex, if there is a cell-specific UL-DL configuration of aggregated serving cells, a D subframe commonly designated to a D subframe in all serving cells may be the subframe having the default value D.

Alternatively, a D subframe which is a common intersection between a UE-specific UL-DL configuration of a serving cell C configured semi-persistently and a cell-specific UL-DL configuration of the serving cell C may be the subframe having the default value D.

In addition, among flexible subframes of the secondary cell, a subframe which is confirmed by a corresponding UE as being configured to a D subframe through dynamic signaling (e.g., a subframe in which a DL grant is transmitted from a corresponding serving cell or in which a DL data channel is scheduled) may also be included. In case of a UE operating with half-duplex, if there is a cell-specific UL-DL configuration of aggregated serving cells, there may be a subframe designated to U in some serving cells while being designated to D in other serving cells. In this case, a subframe configured to U may be used as X, and a subframe designated to D may be used as a D subframe.

In addition, D subframes satisfying the aforementioned condition may have additional restrictions as follows.

i. It shall not be a multicast-broadcast single frequency network (MBSFN) in a situation other than a transmission mode 9.

ii. It shall not be an S subframe in which a specific-length downlink usage is not guaranteed. For example, an S subframe of which D_{W}PTS is less than or equal to 7680T_{S} is excluded.

iii. It shall not correspond to a measurement gap configured to a corresponding UE.

iv. In case of periodic CSI reporting, it shall be a CSI subframe connected to periodic CSI reporting if a CSI subframe set is configured.

Meanwhile, how to designate a CSI measurement reference subframe for aperiodic CSI triggering is a matter to be considered. The aperiodic CSI triggering is transmitted through a UL grant. If the UL grant is transmitted through a serving cell C, a CSI measurement reference subframe for the serving cell C can use a subframe in which the UL grant is transmitted. On the other hand, if cross-carrier scheduling is configured or reporting on a plurality of serving cells is required, there may be a case where a subframe of a serving cell for transmitting a UL grant is D but a subframe of a different serving cell C is X at the same time. Accordingly, in this case, CSI for the serving cell C may not be transmitted, or a previous valid D subframe separated by more than N_{CQI}_{_{—}}_{REF,MIN} subframes may be a CSI measurement reference subframe.

SPS and a synchronization HARQ process may operate only in a subframe having a default value (D, U, etc.) in a TDD frame of a secondary cell. A subframe having a default value D can transmit a synchronization channel, a physical broadcast channel (PBCH), a system information block (SIB), a paging channel, etc. Alternatively, a subframe which transmits the synchronization channel, the PBCH, the SIB, the paging channel, etc., is configured to the subframe having the default value D.

In addition, in case of using an unlicensed-band secondary cell, even if a UE receives a UL grant, the UE may not transmit a PUSCH if it is determined, through secondary cell sensing, that a corresponding serving cell is interfered or is used by another UE.

The UE cannot know a subframe configuration of a secondary cell if there is no signaling of a primary cell. Therefore, the BS can restrict a synchronization retransmission operation or an SPS configuration in a subframe which is not configured to U or D in a secondary cell. Instead, the BS can configure the UE to operate in an asynchronous HARQ process. Alternatively, the number of autonomous synchronous retransmissions which operate without a UL grant can be limited to L, and a UDSX configuration can be maintained in a subframe conforming to a corresponding retransmission period. If L=0, PHICH transmission is preferably not performed.

If one or more TDD serving cells are allocated to the UE and a UDSX configuration is set by using a DCI format through a UE-specific PDCCH for the TDD serving cell, the UE must ensure the number of ACK/NACK information bits for the maximum number of codewords that can be transmitted in a serving cell configured to enable reception in preparation for a case where the UE fails to receive a PDCCH when transmitting ACK/NACK for a PDSCH. That is, irrespective of a UDSX configuration for each subframe of a secondary cell, the maximum number of codewords can be calculated by assuming that all of the flexible subframes are configured to D.

Although a case where the primary cell uses the FDD frame is assumed in FIG. 11, the present invention is not limited thereto. That is, the primary cell may use a TDD frame in which a UL-DL configuration is semi-persistently fixed. In this case, it may be necessary to configure a new timing relation for control signal transmission. The timing relation may be predetermined or may be signaled by using RRC. In addition, a subframe of the primary cell may be flexibly configured such that backward compatibility is not maintained in all subframes of the primary cell or backward compatibility is maintained only in some subframes. Even in this case, the present invention is also applicable.

In addition, the number of codewords that can be transmitted in a subframe configured to D or U as a default value (i.e., a default subframe) and a flexible subframe may be set differently.

Hereinafter, a method of allocating a full TDD frame to a DL or a UL with respect to secondary cells which use the TDD frame will be described. That is, although a DL-UL configuration is indicated in a unit of subframe with respect to the secondary cells which use the TDD frame in FIG. 11, a scheduling method in which one TDD frame is fully configured to a D subframe or a U subframe will be described in embodiments described below.

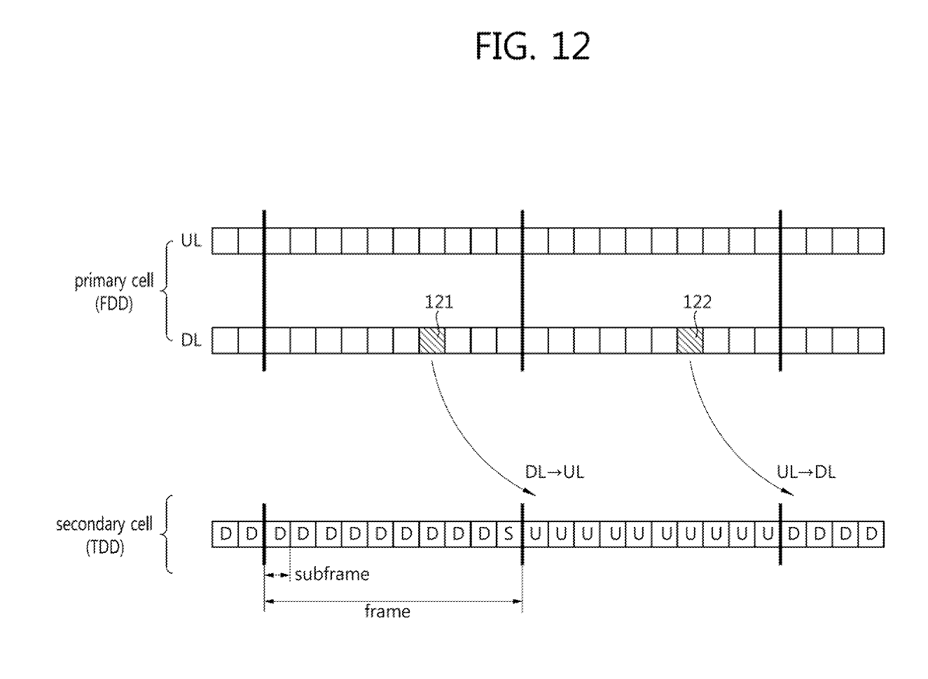

FIG. 12 shows a method of scheduling a secondary cell according to another embodiment of the present invention.

Referring to FIG. 12, a BS transmits information indicating a configuration of a TDD frame of the secondary cell (i.e., UL-DL configuration information) through a subframe 121 of a primary cell. The information indicating the TDD frame of the secondary cell may be transmitted through broadcasting, a common control channel, a UE-specific RRC message, or a UE-specific L1/L2 signal.

The information indicating the configuration of the TDD frame of the secondary cell may be information indicating whether the full TDD frame of the secondary cell is configured with D subframes or U subframes. The information may be given to some secondary cells or a secondary cell group or all secondary cells allocated to the UE.

Upon receiving information indicating the configuration of the TDD frame of the secondary cell in the subframe 121 of the primary cell, the UE may apply it starting from a subframe separated by k subframes from the subframe 121 or may apply a configuration based on the information from the TDD frame of the secondary cell corresponding to a frame located after the frame to which the specific subframe 121 of the primary cell belongs. The value k may be predetermined or signaled. In addition, the value k may be the same value or a different value when a frame change occurs from a TDD frame configured to D subframes to a TDD frame configured to U subframes (or the other way around is also possible).

It can be restricted such that the subframe 121 is transmitted only in a specific subframe of the primary cell to decrease a detection overhead of the UE.

Information indicating the TDD frame configuration of the secondary cell (hereinafter, TDD frame configuration information) may not be necessarily provided in an explicit manner. For example, the UE may recognize that the TDD frame of the secondary cell is configured to U subframes if a UE-specific L1 signal, that is, a DCI format of a PDCCH, is a UL grant. Likewise, if the DCI format of the PDCCH is a DL grant, the UE may recognize that the TDD frame of the secondary cell is configured to D subframes. As such, if the configuration of the TDD frame of the secondary cell is recognized based on the content of the DCI format transmitted in the primary cell, blind decoding of some DCI formats can be omitted in the configured TDD frame. For example, if the TDD frame is configured to D subframes, blind decoding for a DCI format including a UL grant can be omitted.

The primary cell can use any one of TDD and FDD frames, but preferably uses the FDD frame. Further, the secondary cell uses the TDD frame.

Referring back to FIG. 12, if the two consecutive TDD frames in the secondary cell are configured to {D, U} in that order, a last subframe of the TDD frame configured to D may be configured to an S subframe. Alternatively, a first subframe of the TDD frame configured to U may be configured to an S subframe. This is to configure some subframes located in a boundary to S subframes so that D and U are smoothly changed. Likewise, if the two consecutive TDD frames in the secondary cell are configured to {U, D} in that order, a last subframe of the TDD frame configured to U may be configured to an S subframe. Alternatively, a first subframe of the TDD frame configured to D may be configured to an S subframe. That is, if the two consecutive frames of the secondary cell are allocated to different transmission links, at least one of subframes adjacent to a boundary of the two consecutive frames is configured to a special subframe.

The TDD frame of the secondary cell can also be changed to U or D subframes when there is triggering through the primary cell in a state in which the TDD frame is configured to D or U as a default value. In this case, the default value may change only during a duration of N frames, and if the duration of N frames is over, may be restored to the original default value. The value N may be a fixed value or may be signaled by using an RRC message.

Some TDD frames of the secondary cell can be used for CQI measurement or SRS transmission by fixing a UDSX configuration for each subframe. The some TDD frames may be used for D alone, U alone, or both U and D by performing a UD configuration for each subframe. CQI measurement or periodic CQI transmission and periodic SRS transmission may be restricted to be performed only in a subframe fixed to D or U as a default value. If there is no TDD frame in which a UDSX configuration is fixed for each subframe, the BS may trigger SRS transmission and/or CQI measurement to the UE. The TDD frame in which the UDSX configuration is fixed for each subframe may use a configuration in which U, D, and S subframes coexist in one TDD frame as shown in the UL-DL configuration of Table 2 above. In addition, the TDD frame in which the UDSX configuration is fixed for each subframe may be predetermined or signaled. SPS and a synchronization HARQ process may operate in subframes having default values U, D, and S.

The UE may know whether the TDD frame of the secondary cell is configured to U or D, by receiving UE-specific L1 signaling in any subframe of the primary cell. In this case, the UE can use all subframes or last M (e.g., M=1) subframes for the purpose of CQI measurement, periodic CQI transmission, or periodic SRS transmission in a TDD frame of a secondary cell confirmed to be configured to U or D.

If the two consecutive frames of the secondary cell are configured to {D, U} and/or {U, D} and thus a change occurs between UL and DL, the use of some OFDM symbols of a frame at which the change starts may be restricted to avoid interference. That is, a change gap can be configured. Data to be transmitted in the OFDM symbol may be subjected to rate matching or may be punctured. The number of OFDM symbols of which use is restricted may be determined to a predetermined value or may be determined according to a value DwPTS or UpPTS. Alternatively, the BS may report the number of the OFDM symbols to the UE by using system information and L1/L2/L3 signaling. In addition, the use of the OFDM symbol may be selectively restricted such that the restriction is applied only when configured to {D, U} or only when configured to {U, D}.

Alternatively, if the two consecutive frames of the secondary cell are configured to {D, U} and/or {U, D}, the use of some OFDM symbols of the frames may be restricted in every case to avoid interference.

The UE cannot know a TDD frame configuration of a secondary cell if there is no signaling of a primary cell. Therefore, the BS can restrict a synchronization retransmission operation or an SPS configuration in a TDD frame which is not configured to U or D in a secondary cell. Instead, the BS can configure the UE to operate in an asynchronous HARQ process. Alternatively, the number of autonomous synchronous retransmissions which operate without a UL grant can be limited to L, and a UDSX configuration can be maintained in a subframe conforming to a corresponding retransmission period. If L=0, PHICH transmission is preferably not performed.

If one or more TDD serving cells are allocated to the UE and a UD configuration is set for the TDD frame by using a DCI format through a UE-specific PDCCH for the TDD serving cell, the UE must ensure the number of ACK/NACK information bits for the maximum number of codewords that can be transmitted in a serving cell configured to enable reception in preparation for a case where the UE fails to receive a PDCCH when transmitting ACK/NACK for a PDSCH. That is, irrespective of a UD configuration for each TDD frame of a secondary cell, the maximum number of codewords is calculated by assuming that all TDD frames are configured to D.

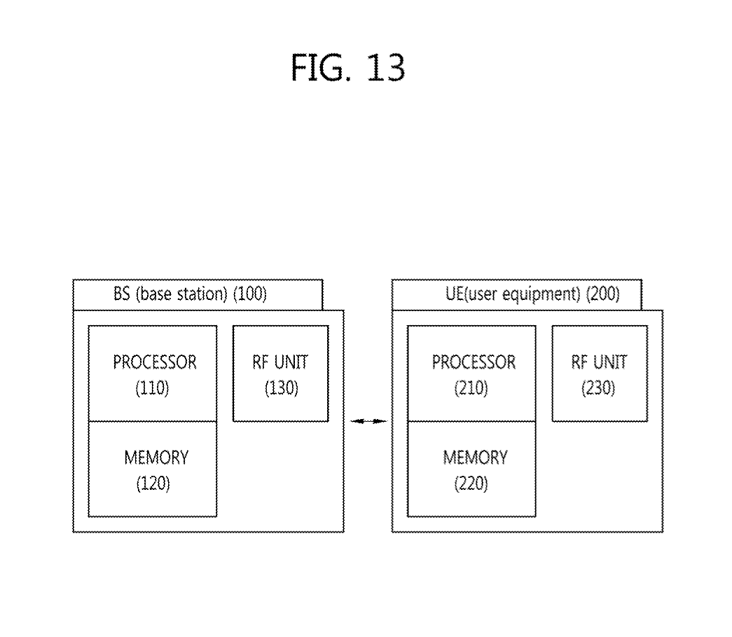

FIG. 13 shows a structure of a BS and a UE according to an embodiment of the present invention.

A BS 100 includes a processor 110, a memory 120, and a radio frequency (RF) unit 130. The processor 110 implements the proposed functions, procedures, and/or methods. For example, the processor 110 transmits UL-DL configuration information on a TDD frame used in a second serving cell through a first serving cell, and communicates with a UE through a subframe of the second serving cell configured by the UL-DL configuration information. In addition, the processor 110 transmits UE-specific UL-DL configuration information through the first serving cell. The memory 120 coupled to the processor 110 stores a variety of information for driving the processor 110. The RF unit 130 coupled to the processor 110 transmits and/or receives a radio signal.

A UE 200 includes a processor 210, a memory 220, and an RF unit 230. The processor 210 implements the proposed functions, procedures, and/or methods. For example, the processor 210 may receive UL-DL configuration information on a second serving cell and UE-specific UL-DL configuration information from a BS through a higher layer signal of a first serving cell. In addition, the processor 210 determines a UDSX configuration for each frame or each subframe of a TDD frame used in the second serving cell on the basis of the UL-DL configuration and the UE-specific UL-DL configuration information. The memory 220 coupled to the processor 210 stores a variety of information for driving the processor 210. The RF unit 230 coupled to the processor 210 transmits and/or receives a radio signal.

The processors 110 and 210 may include an application-specific integrated circuit (ASIC), a separate chipset, a logic circuit, a data processing unit, and/or a converter for mutually converting a baseband signal and a radio signal. The memories 120 and 220 may include a read-only memory (ROM), a random access memory (RAM), a flash memory, a memory card, a storage medium, and/or other equivalent storage devices. The RF units 130 and 230 may include one or more antennas for transmitting and/or receiving a radio signal. When the embodiment of the present invention is implemented in software, the aforementioned methods can be implemented with a module (i.e., process, function, etc.) for performing the aforementioned functions. The module may be stored in the memories 120 and 220 and may be performed by the processors 110 and 210. The memories 120 and 220 may be located inside or outside the processors 110 and 210, and may be coupled to the processors 110 and 210 by using various well-known means.

While the present invention has been particularly shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A scheduling method of a base station (BS) in a carrier aggregation system, the method comprising:
transmitting uplink-downlink (UL-DL) configuration information on a time division duplex (TDD) frame used in a second serving cell through a first serving cell; and
communicating with a user equipment (UE) through a subframe of the second serving cell configured by the UL-DL configuration information,
wherein the first serving cell and the second serving cell are serving cells allocated to the UE.

2. The method of claim 1, wherein the first serving cell is a primary cell in which the UE performs an initial connection establishment procedure or a connection re-establishment procedure with respect to the BS.

3. The method of claim 2, wherein the second serving cell is a secondary cell additionally allocated to the UE in addition to the primary cell.

4. The method of claim 1, wherein the first serving cell is a serving cell in which the UE establishes a radio resource control (RRC) connection with the BS, and the second serving cell is a serving cell additionally allocated to the UE.

5. The method of claim 1, wherein the first serving cell uses a frequency division duplex (FDD) frame in which downlink transmission and uplink transmission are performed in different frequency bands.

6. The method of claim 5, wherein the second serving cell uses a TDD frame in which downlink transmission and uplink transmission are performed in the same frequency band at different times.

7. The method of claim 1, wherein all of the first serving cell and the second serving cell use a TDD frame, while using different UL-DL configurations.

8. The method of claim 1, wherein the UL-DL configuration information indicates each of subframes existing in each TDD frame used in the second serving cell as a UL subframe, a DL subframe, or a special subframe.

9. The method of claim 1, wherein the UL-DL configuration information indicates each TDD frame used in the second serving cell as a UL frame or a DL frame in a unit of frame.

10. The method of claim 9, wherein if two consecutive frames of the second serving cell are allocated to different transmission links by the UL-DL configuration information, at least one of subframes adjacent to a boundary of the two consecutive frames is configured to a special subframe.

11. The method of claim 1, further comprising:
transmitting UE-specific UL-DL configuration information applied to the UE through the first serving cell.

12. The method of claim 11, wherein if a subframe configured by the UE-specific UL-DL configuration information is allocated to a transmission link different from that of a subframe configured by the UL-DL configuration information, the subframe is not used by the UE.

13. The method of claim 1, wherein the UL-DL configuration information is transmitted through an RRC message.

14. The method of claim 1, wherein the UL-DL configuration information is the same information as UL-DL configuration information to be broadcast as system information in the second serving cell.

15. A method of operating a UE in a carrier aggregation system, the method comprising:
receiving UL-DL configuration information on a TDD frame used in a second serving cell through a first serving cell; and
communicating with a BS through a subframe of the second serving cell configured by the UL-DL configuration information,
wherein the first serving cell and the second serving cell are serving cells allocated to the UE.

16. The method of claim 15, wherein the UL-DL configuration information is the same information as UL-DL configuration information to be broadcast as system information in the second serving cell.

17. A method of operating a UE in a carrier aggregation system, the method comprising:
receiving scheduling information on a second subframe of a second serving cell through a first subframe of a first serving cell;
determining a UL-DL configuration of the second subframe on the basis of the scheduling information; and
communicating with a BS in the second subframe,
wherein the UL-DL configuration indicates a specific subframe type to which the second subframe belongs between a UL subframe and a DL subframe.

18. The method of claim 17, wherein the scheduling information is a DL grant or a UL grant.

19. The method of claim 18, wherein if the DL grant schedules the second subframe, the second subframe is configured to a DL subframe.

20. The method of claim 18, wherein if the UL grant schedules the second subframe, the second subframe is configured to a UL subframe.

21. An apparatus comprising:
a radio frequency (RF) unit transmitting and receiving a radio signal; and
a processor coupled to the RF unit,
wherein the processor transmits UL-DL configuration information on a TDD frame used in a second serving cell through a first serving cell, and transmits and receives a signal through a subframe of the second serving cell configured by the UL-DL configuration information, and
wherein the first serving cell uses an FDD frame as a primary cell, and the second serving cell uses a TDD frame as a secondary cell.
